(19) United States
(12) Patent Application Publication
(10) Pub. No.: US 2004/0249917 A1
(43) Pub. Date: Dec. 9, 2004

(54) Data flow management method

(76) Inventor: Cheng Yung Lin, Tau Yuan Hsien (TW)

Correspondence Address: CHENG YUNG LIN, 235 P.O. BOX 10-69, Chung-Ho, Taipei, TW

(21) Appl. No.: 10/454,458

(22) Filed: Jun. 5, 2003

(51) Int. Cl. G06F 15/173

(52) U.S. Cl. 709/223; 709/221

(57) ABSTRACT

A flow management method having a data traffic control mechanism so as to determine data transfers between a data accessing point and a plurality of workstations; the method comprising the step of: the workstation waiting for a priority setting package from a data accessing point, wherein in the waiting time, the workstation does not process any data package other than management package, if no priority setting package being received in a predetermined time period, the workstation being set as a normal workstation, i.e., delay time for transferring data being set as zero; after the workstation receiving a priority setting package, the workstation giving an acknowledge to the data accessing point; the workstation setting a transfer delay time according to the priority setting package; the data accessing point registering the priority of the workstation; and the data being sent to the data accessing point based on the delay time.

### FIELD OF THE INVENTION

The present invention relates to data traffic control, and especially to data flow management method which sets priorities to devices for receiving data so that the transmission speed is increased.

### BACKGROUND OF THE INVENTION

In the prior art data flow control, only speeds of uplink transmission and downlink transmission are controlled. In transmission, generally, a data buffer is used to store data so that data must be duplicated in the buffer. Thus the speed is low and as a result, the data flow cannot be controlled effectively. The data accessing point cannot set priorities to downlink devices. As a result, the data will jam in the channel and long time periods are necessary. However this is inconvenient to users and cost is increased.

### SUMMARY OF THE, INVENTION

Accordingly, the primary object of the present invention is to provide a flow management method having a data traffic control mechanism so as to determine data transfers between a data accessing point and a plurality of workstations. The method comprises the step of: the workstation waiting for a priority setting package from a data accessing point, wherein in the waiting time, the workstation does not process any data package other than management package; if no priority setting package being received in a predetermined time period, the workstation being set as a normal workstation, i.e. delay time for transferring data being set as zero, after the workstation receiving a priority setting package, the workstation giving an acknowledge to the data accessing point; the workstation setting a transfer delay time according to the priority setting package the data accessing point registering the priority of the workstation; and the data being sent to the data accessing point based on the delay time.

The various objects and advantages of the present invention will be more readily understood from the following detailed description when read in conjunction with the appended drawing.

### BRIEF DESCRIPTION OF THE DRAWINGS

FIG. 1 shows a flow diagram of the present invention for normal operation.

FIG. 2 shows the flow diagram of the present invention where the workstation is not set in the priority table.

FIG. 3 shows one example of the priority table of the present invention.

FIG. 4 shows the state diagram of the data format of the present invention,

FIG. 5 is a structure diagram of the present invention.

FIG. 6 is a structure diagram about the data transfer of the present invention.

### DETAILED DESCRIPTION OF THE INVENTION

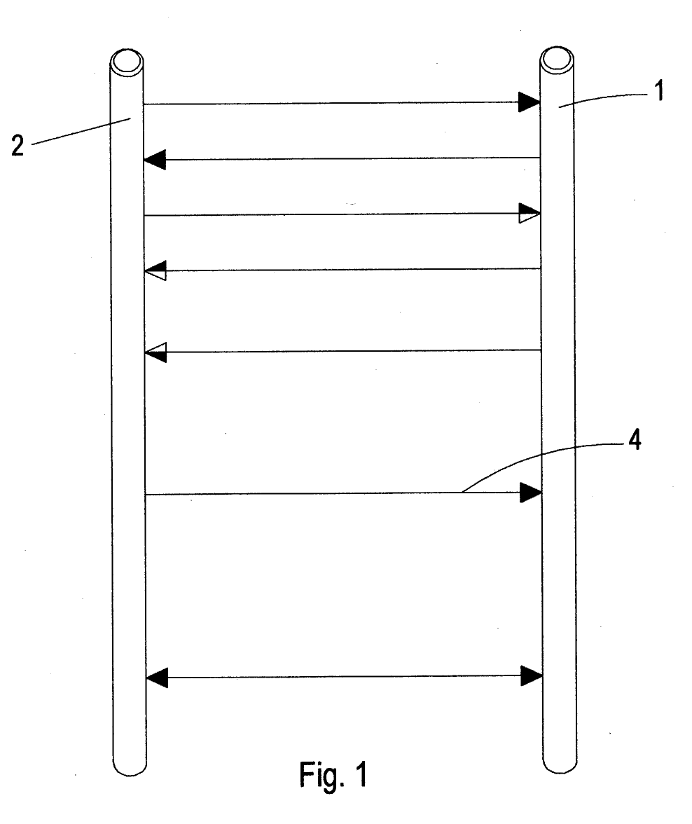

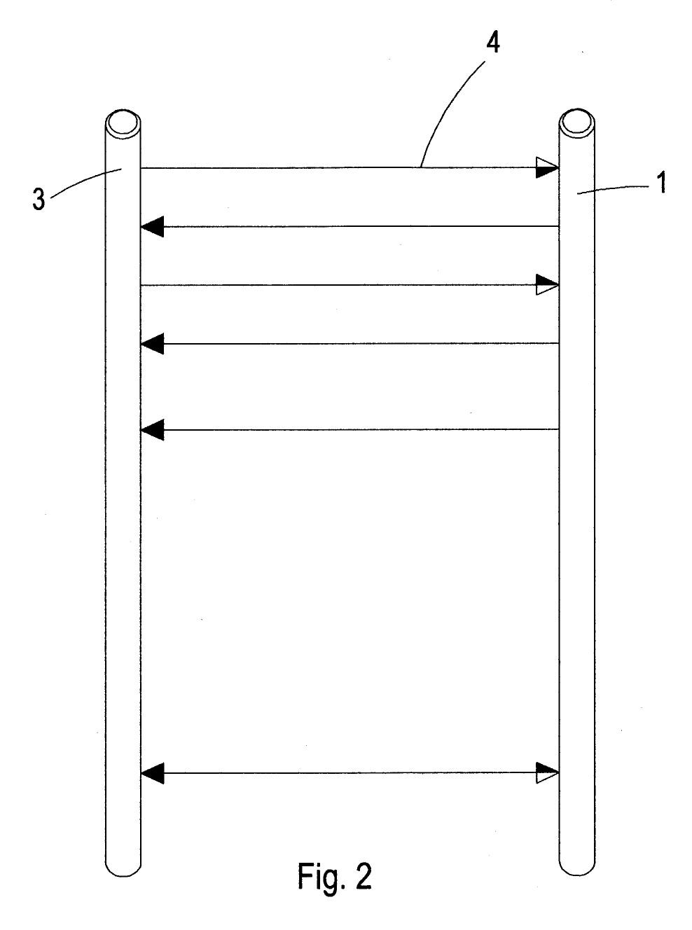

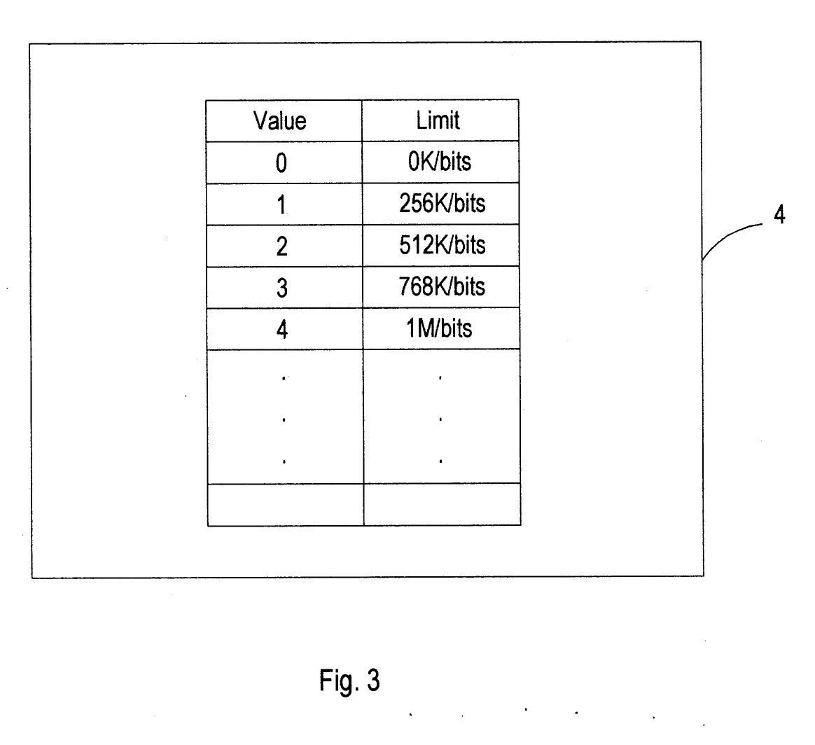

Referring to FIGS. 1, 2 and 3, a flow management is provided in the present invention, where a plurality of data accessing points 1 and workstations 2 are provided. The data accessing points 1 and workstations 2 are supported wide band control mechanism. The operations of the present invention comprises the steps of:

a. Building a data sequence in the data accessing point 1;

b. The data accessing point 1 registering and connecting workstations 2;

c. The data accessing point 1 sending a priority package to a workstation 2 according to a priority table 4 in the data accessing point 1;

d. The data accessing point 1 waiting for an acknowledge package from the workstation 2 within a predetermined time period, wherein in this time period, in Q package is sent to the workstation 2;

e. If no response from the workstation 2, the data accessing point 1 resending the priority package to the workstation 2,

f. Repeating the processes in steps c to e within a predetermined time, if no response is acquired, then the workstation 2 being set as a non-wide band workstation 3 which will be processed to rules, of non-wideband workstation;

g. If the data accessing point 1 receiving the priority package, the identification of bandwidth is complete;

h. The workstation 2 starting to receive data;

i. If any data to be stored to the workstation 2 from the data accessing point 1, the data accessing point 1 storing the data to a data sequence for bandwidth control and setting a delay time for the data to be transferred according to the priority of the workstation 2 to receive the data;

j. When the delay time is zero, the data being sent to the workstation 2;

k. If there are several data transferred to different workstations 2 and having zero, delay times then the data being sent according to the priority of the workstation 2. For the workstation 2 having larger priority, the data accessing point 1 transfers a larger amount of data to be workstation 2. For example, for a workstation 2 with a priority of 7, the data accessing point 1 transfers data is twice of the data to be sent to a workstation having a priority of 6.

In the present invention, for example, there are seven levels being set in the priority table. A first in first out (FIFO) logic is used. If the data amount to be transferred is larger than the largest amount allowable transferred, in the channel, then the data is placed at the final position of the data sequence.

In the present invention, the delay time can be calculate as the following.

$$\begin{matrix}1000000 / ( Max Throghput ) / Max Ethernet Data ength ) - \\ 1000000 / ( Limit Throughput ( bytes \text{/} sec ) Max Ethernet Data Length ) \vert = \\ Delay Time μ s \text{/} record ∘\end{matrix}$$

For example for 1M bit/sec transmission rate:

$$\begin{matrix}1000000 / ( ( 7 * 1024 * 1024 ) / 8 / 1500 ) - 1000000 / ( ( 1 * 1024 * 1024 ) / 8 / \\ 1500 ) = \vert 1000000 / 612 - 1000000 / 87 \vert = 11494 μ s \text{/} record ∘\end{matrix}$$

The priority can be determined by the following equation:

(Max Throghput(bytes/sec)/Max Ethernet Data Length)Max Ethernet Data Length=priority Counter

For example, for Limit Throughput1M bit/sec; the priority is:

((7*1024*1024)/8/1500)/((1*1024*1024)/8/1500)=612/87=7.

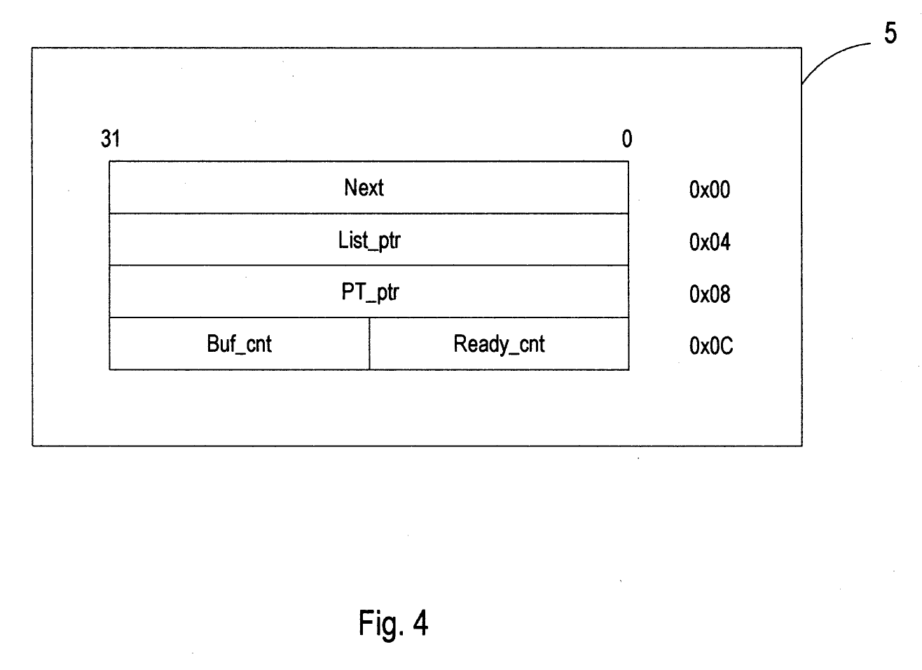

Referring to FIG. 4, the data structure of the present invention is illustrated. The data is ordered from Q to 31. The first data is pointed to the 0×00 in the priority table, the second data is pointed to 0×04 in the priority table, the third data is pointed to the 0×08 in the priority table, and the fourth data is registered data and represents a prepare state, 0×0c.

The present invention provides a data traffic control mechanism to determine the data transfer between the data accessing point 1 and workstations 2. The method of the present invention comprises the step of:

a. The workstation 2 waiting for a priority setting package from a data accessing point 1, wherein in the waiting time, the workstation 2 does not process any data package other than management package.

b. If no priority setting package being received in a predetermined time period, the workstation 2 being set as a normal workstation, i.e., delay time for transferring data being set as zero.

c. After the workstation 2 receiving a priority setting package, the workstation 2 giving an acknowledge to the data accessing point 1.

d. The workstation 2 setting a transfer delay time according to the priority setting package.

e. The data accessing point 1 registering the priority of the workstation 2.

f. The data being sent to the data accessing point 1 based on the delay time.

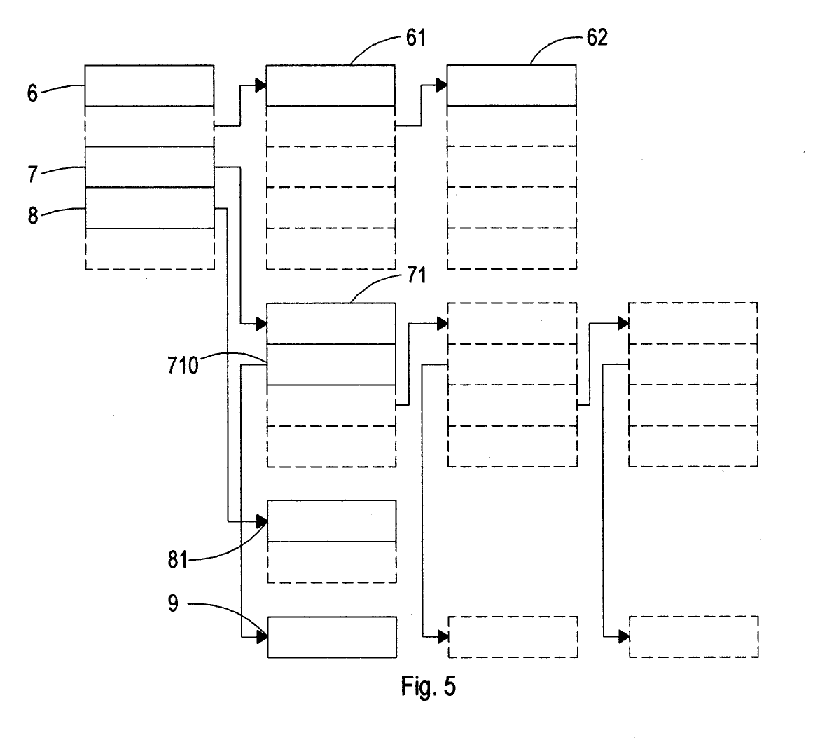

The detail about the data transfer of the present invention is illustrated in FIG. 5. The data sequence 6 about the priority (with a lowest priority of 0, and highest priority of 7) is pointed to the pointer 61, 62. The data sequence 7 is sent to the pointer 71. At the same time, the priority pointer 8 is sent to the pointer 81. According to the data sequence 7 and the pointer 81, the data in pointer 710 can be pointed to the data 9.

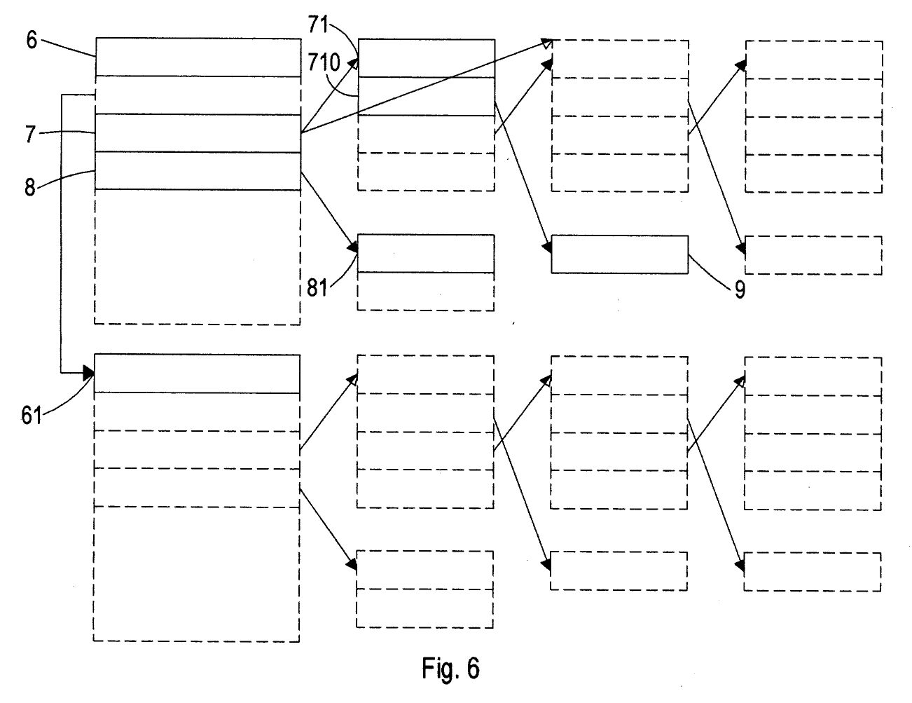

Referring to FIG. 6, a data sequence 6 with a plurality of data to be sent, the data having a highest priority, 7, is firstly sent to the pointers 61, 62. If the data to be sent is larger than a maximum transfer amount, then the data to be sent is retraced to a last position of the data sequence 6 and the priority is set with a lower priority, if the data with higher priority is sent out, then the data with lower priority is added with 1. The data having the higher priority is sent earlier than those with lower priority.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A data flow management method used in a system having a data accessing points and a plurality of workstations; the method comprising the steps of:
a. building a data sequence in the data accessing point;
b. registering and connecting the data accessing point to a workstations to receive data from the data accessing point;
c. sending a priority setting package from the data accessing point to the workstation according to a priority table in the data accessing point, the priority table registering priorities of the workstations;
d. the data accessing point waiting for an acknowledge package from the workstation within a predetermined time period, wherein in this time period, no package being sent to the workstation;
e. if no response from the workstation, resending the priority package to the workstation;
f. repeating the processes in steps c to e within a predetermined time, if no response being acquired, then the workstation being set as a no priority setting workstation;
g. if the data accessing point receiving the priority package, the identification of bandwidth being complete;
h. the workstation starting to receive data from the data accessing point;
i. if any data from the data accessing point to be stored to the workstation, the data accessing point storing the data to a data sequence and setting a delay time for the data to be transferred according to the priority of the workstation to receive the data, and
j. when the delay time is zero, the data being sent to the workstation;
k. if there are several data transferred to different workstations and having zero delay times, then the data being sent according to the priority of the workstation; for the workstation having a larger priority, the data accessing point transfers a larger amount of data to be workstation.

2. The data flow management method as claimed in claim 1, wherein there are seven levels being set in the priority table; and first in first out (FIFO) logic is used; if the data amount to be transferred is larger than the largest amount allowable transferred in the channel, then the data is placed at a final position of the data sequence.

3. The data flow management method as claimed in claim 1, wherein the delay time is equal to 1000000/(makimum throghput)/max Ethernet data length)−1000000/(limit throughput (bytes/sec)×max Ethernet data length)|=Delay Time, μs/record.

4. The data flow management method as claimed in claim 1, wherein the priority is equal to (Max Throghput (bytes/sec)/Max Ethernet Data Length) Max Ethernet Data Length=priority Counter

5. A data flow management method having a data traffic control mechanism for determining data transfers between a data accessing point and a plurality of workstations; the method comprising the step of:
a. the workstation waiting for a priority setting package from a data accessing point, wherein in the waiting time, the workstation does not process any data package other than management package;
b. if no priority setting package being received in a predetermined time period, the workstation being set as a normal workstation, i.e., delay time for transferring data being set as zero;
c. after the workstation receiving a priority setting package, the workstation giving an acknowledge to the data accessing point
d. the workstation setting a transfer delay time according to the priority setting package;
e. the data accessing point registering the priority of the workstation; and
f. the data being sent to the data accessing point based on the delay time.

6. The data flow management method as claimed in claim 5, wherein the delay time is equal to 1000000/(maximum throghput)/max Ethernet data length)−1000000/(limit throughput (bytes/sec)×max Ethernet data length)|=Delay Time μs/record.

7. The, data flow management method as claimed in claim 5, wherein the priority is equal to (Max Throghput(bytes/sec)/Max Ethernet Data Length) Max Ethernet Data Length=priority Counter.
